(19) United States
(12) Patent Application Publication
(10) Pub. No.: US 2026/0018929 A1
(43) Pub. Date: Jan. 15, 2026

(54) WIRELESS POWER SUPPLY DEVICE AND WIRELESS POWER SUPPLY SYSTEM

(71) Applicant: KABUSHIKI KAISHA TOSHIBA, Tokyo (JP)

(72) Inventors: Toshiya MITOMO, Yokohama Kanagawa (JP); Yukako TSUTSUMI, Kawasaki Kanagawa (JP); Kazuki ARAI, Yokohama Kanagawa (JP)

(73) Assignee: KABUSHIKI KAISHA TOSHIBA, Tokyo (JP)

(21) Appl. No.: 19/238,931

(22) Filed: Jun. 16, 2025

(30) Foreign Application Priority Data
Jul. 12, 2024 (JP) 2024-112783

(51) Int. Cl. H02J 50/10; H02J 7/04; H02J 50/80

(52) U.S. Cl. CPC H02J 50/10; H02J 7/04; H02J 50/80

(57) ABSTRACT

According to one embodiment, a wireless power supply device includes: a receiver configured to receive a first signal from a power reception device via a plurality of antennas; and a controller configured to determine a plurality of weights used for the plurality of antennas based on a reception signal of the first signal, wherein the receiver receives a second signal from the power reception device by reception beam forming based on the plurality of weights, the controller determines transmission power of a power signal to be transmitted to the power reception device based on reception power of the second signal, and the wireless power supply device further comprises a transmitter configured to transmit the power signal based on the transmission power by transmission beam forming based on the plurality of weights.

### CROSS REFERENCE TO RELATED APPLICATIONS

This application is based upon and claims the benefit of priority from the prior Japanese Patent Application No. 2024-112783, filed on Jul. 12, 2024, the entire contents of which are incorporated herein by reference.

### FIELD

Embodiments described herein relates to a wireless power supply device and a wireless power supply system.

### BACKGROUND

Conventionally, there has been a method of measuring reception power in a power reception device in order to prevent supply power to the power reception device supplied as microwaves from becoming excessive (input that causes output saturation or permanent damage or the like of a rectifier, for example). In addition, there has been a method of measuring the reception power by transmitting a test beam of weak power. Further, there has been a method of receiving a beacon signal transmitted from a power reception device by a power transmission device, thereby determining transmission power of the power transmission device from the radio wave intensity.

A configuration of measuring reception power in a power reception device requires a mechanism of measuring power on the side of the power reception device, leading to cost increase. Further, direct measurement of the reception power may cause a problem of a breakage risk.

A method of using a weak test beam is effective in terms of breakage prevention, but it has a problem of a power supply time efficiency decline with unneeded exchange before starting power transmission. In addition, there is a problem of a breakage risk due to nonlinearity and variation of input/output power characteristics of a rectifier.

In the method of receiving a beacon signal transmitted from a power reception device by a power transmission device, antenna radiation characteristics differ between the time of receiving a beacon from the power reception device and the time of actually supplying power to the power reception device (at the time of beam forming power supply). Therefore, even when transmission power of power supply is determined from the radio wave intensity of the beacon signal, it is difficult to reduce saturation and permanent damage risks for the power reception device.

### BRIEF DESCRIPTION OF THE DRAWINGS

FIG. 1 is a block diagram illustrating an entire configuration of a wireless power supply system according to a first embodiment;

FIG. 2 is a diagram illustrating an example of an operation flow of the wireless power supply system in FIG. 1;

FIG. 3 is a block diagram illustrating an entire configuration of a wireless power supply system according to a second embodiment;

FIG. 4 is a diagram illustrating an example of an operation flow of the wireless power supply system in FIG. 3;

FIG. 5 is a block diagram illustrating an entire configuration of a wireless power supply system according to a third embodiment;

FIG. 6 is a diagram illustrating an example of an operation flow of the wireless power supply system in FIG. 5;

FIG. 7 is a block diagram illustrating an entire configuration of a wireless power supply system according to a fourth embodiment; and

FIG. 8 is a block diagram illustrating an entire configuration of a wireless power supply system according to a fifth embodiment.

### DETAILED DESCRIPTION

According to one embodiment, a wireless power supply device includes: a receiver configured to receive a first signal from a power reception device via a plurality of antennas; and a controller configured to determine a plurality of weights used for the plurality of antennas based on a reception signal of the first signal, wherein the receiver receives a second signal from the power reception device by reception beam forming based on the plurality of weights, the controller determines transmission power of a power signal to be transmitted to the power reception device based on reception power of the second signal, and the wireless power supply device further comprises a transmitter configured to transmit the power signal based on the transmission power by transmission beam forming based on the plurality of weights.

Hereinafter, the present embodiments will be described with reference to the drawings.

### First Embodiment

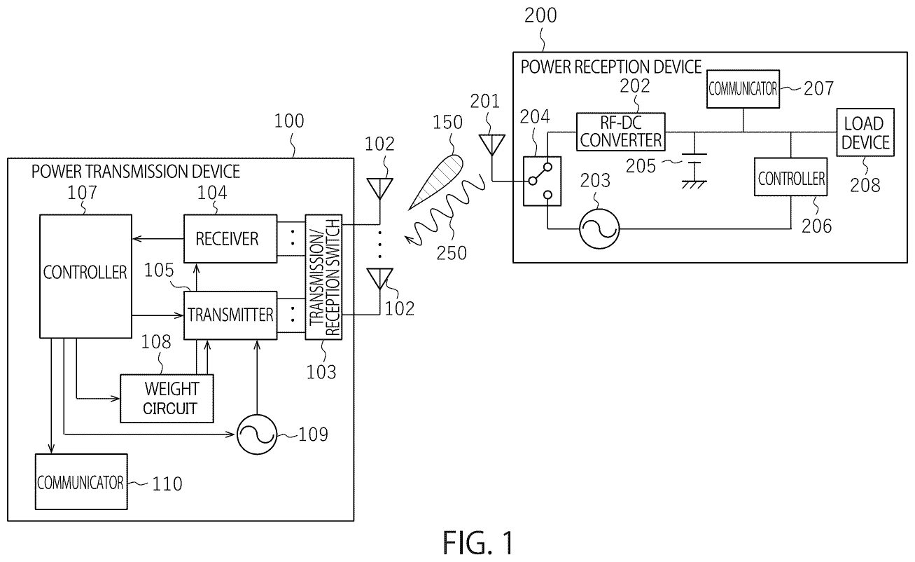

FIG. 1 is a block diagram illustrating an entire configuration of a wireless power supply system according to the present embodiment.

The wireless power supply system in FIG. 1 includes a power transmission device 100 and a power reception device 200, and performs wireless power transmission (wireless power supply) by electromagnetic waves such as microwaves from the power transmission device 100 to the power reception device 200. The wireless power supply system includes only one power reception device 200 in an example in FIG. 1, however, it may include a plurality of power reception devices 200.

The power reception device 200 may be an arbitrary device as long as the device receives power supply from the power transmission device 100 and operates based on the supplied power. For example, the power reception device 200 may be used in a sensor device attached to a robot arm, a camera for stationary observation, a sensor that monitors processes in a plant, a pickup device for articles such as merchandise in a distribution center, a lock mechanism control device of an automatically lockable door, or a smartphone.

### [Power Reception Device 200]

The power reception device 200 includes an antenna 201 for power reception, an RF-DC converter 202 (a rectifier or a rectifier and a storage battery charge circuit or the like), a signal generator 203 (a transmitter), a transmission/reception switch 204, a storage battery 205, a controller 206, a communicator 207, and a load device 208. The RF-DC converter 202, the signal generator 203, the transmission/reception switch 204, the controller 206, and the communicator 207 are realized by at least either of an analog circuit that performs analog signal processing and a digital circuit that performs digital signal processing. The digital circuit may be a CPU (Central Processing Unit), a DSP (Digital Signal Processor), a general-purpose processor, a microprocessor, an ASIC (Application Specific Integrated Circuit), an FPGA (Field Programmable Gate Array), or a combination thereof.

The transmission/reception switch 204 switches a connection target of the antenna 201 between the RF-DC converter 202 and the signal generator 203. The antenna 201 is connected to the RF-DC converter 202 at the time of reception, and is connected to the signal generator 203 at the time of transmission.

The signal generator 203 generates a beacon signal 250 of a predetermined frequency using an oscillator, and transmits it to the power transmission device 100 via the antenna 201. The signal generator 203 functions as a transmitter that transmits the beacon signal 250. The beacon signal 250 corresponds to an example of a predetermined first signal or second signal. The beacon signal 250 is a signal that includes a predetermined pattern, and is used to estimate a channel with the power reception device 200 on the side of the power transmission device 100. The signal that includes the predetermined pattern also includes a non-modulated signal or a signal which does not include data, a sine wave signal for example. Transmission power of the beacon signal 250 is known to the power transmission device 100, and is predetermined for example. A frequency of the beacon signal 250 may be same as or similar to a frequency of a power signal transmitted from the power transmission device 100. Being similar includes a case where there is an error of about 10%.

The RF-DC converter 202 is a rectifier that converts AC to DC. More specifically, the RF-DC converter 202 converts an AC power signal (a power supply signal) 150 received from the power transmission device 100 by the antenna 201 to DC and outputs DC power. The power supply signal 150 is a signal of a microwave or the like.

The storage battery 205 stores the DC power output from the RF-DC converter 202. The stored power can be used as operation power of the communicator 207, the controller 206, the load device 208, the RF-DC converter the 202, signal 203, and generator the transmission/reception switch 204, respectively.

The communicator 207 communicates information with a communicator 110 of the power transmission device 100. For example, the communicator 207 transmits information (beacon power information) regarding the transmission power of the beacon signal to the power transmission device 100 according to an instruction of the controller 206. The transmission power is, for example, antenna power or equivalent isotropic radiated power (EIRP).

In addition, the communicator 207 transmits information (optimum reception power information) regarding optimum reception power of wireless power supply to be received by the power reception device 200 to the power transmission device 100. The optimum reception power is determined according to a power conversion characteristic of the RF-DC converter 202. The optimum reception power is an example of reception power desired by the power reception device 200. The information regarding the optimum reception power may be, for example, information regarding maximum allowable power or information on a range of the reception power that the power reception device 200 can allow (a range of power where desired conversion efficiency can be obtained). Further, when a beacon signal transmission request (a transmission request for a first beacon signal, a transmission request for a second beacon signal) is received from the power transmission device 100, the communicator 207 sends the transmission request for a pertinent beacon signal to the controller 206.

A wireless standard of a communication scheme used in the communicator 207 may be arbitrary. For example, there are communication standards of Bluetooth Low Energy (BLE), a wireless LAN (Local Area Network), and 920 MHz band. The communicator 207 includes a communication antenna different from the antenna 201, and performs communication using the communication antenna. However, a configuration that the communicator 207 performs the communication using the antenna 201 is not excluded. Note that a communication target of the communicator 207 is not limited to the power transmission device 100. For example, the communicator 207 may communicate with a master device that controls the plurality of power reception devices 200. At that time, the power transmission device 100 may be the master device. The communication with the master device is performed by the communicator 207, or may be performed by a communicator provided separately from the communicator 207. In this case, the communication scheme with the master device may be different from the communication scheme with the power transmission device 100.

The controller 206 controls the entire power reception device 200, and controls at least one or all of the signal generator 203, the RF-DC converter 202, the transmission/reception switch 204, and the communicator 207 for example. When the beacon signal transmission request (the transmission request for the first beacon signal, the transmission request for the second beacon signal) from the power transmission device 100 is received in the communicator 207, the controller 206 performs control so as to transmit the beacon signal (the first beacon signal, the second beacon signal) to the power transmission device 100 according to the request.

### [Power Transmission Device 100]

The power transmission device 100 includes a plurality of antennas 102, a transmission/reception switch 103, a receiver 104, a transmitter 105, a controller 107 (a phase/amplitude detector), a weight circuit 108, a high frequency device 109, and the communicator 110. The transmission/reception switch 103, the receiver 104, the transmitter 105, the controller 107, the weight circuit 108, the high frequency device 109, and the communicator 110 are realized by at least either of an analog circuit that performs analog signal processing and a digital circuit that performs digital signal processing. The digital circuit may be a CPU, a DSP, a general-purpose processor, a microprocessor, an ASIC, an FPGA, or a combination thereof.

The power transmission device 100 is operated based on commercial power supply supplied from outside or power supplied from an external power storage device. However, the power transmission device 100 may include a storage battery inside and may operate based on stored power of the storage battery.

The transmission/reception switch 103 switches a connection target of the plurality of antennas 102 between the receiver 104 and the transmitter 105. The plurality of antennas 102 are connected to the receiver 104 at the time of reception, and are connected to the transmitter 105 at the time of transmission.

The high frequency device 109 (a signal generator) includes a local oscillator that generates a local signal, and uses the local oscillator to generate the power supply signal 150 (the power signal) to the power reception device 200. The local signal is, for example, a high frequency analog signal. The high frequency device 109 sends the local signal generated by the local oscillator to the transmitter 105 as the power supply signal 150. The high frequency device 109 may send a signal obtained by amplifying the local signal by an amplifier to the transmitter 105 as the power supply signal 150. The high frequency device 109 may frequency-convert the local signal before or after amplification, and may further band-control the signal after frequency conversion using a filter.

The communicator 110 communicates information with the communicator 207 of the power reception device 200. For example, the communicator 110 receives the information regarding the transmission power of the beacon signal from the power reception device 200. In addition, the communicator 110 receives the information (the optimum reception power information) regarding the optimum reception power of the wireless power supply from the power reception device 200. The communicator 110 sends the received information to the controller 107. Further, the communicator 110 transmits the beacon signal transmission request (the transmission request for the first beacon signal, the transmission request for the second beacon signal) to the power reception device 200 according to an instruction of the controller 107. The wireless standard used in the communicator 110 may be arbitrary. Details of the wireless standard have been described in the description of the power reception device 200 and are therefore omitted here.

The receiver 104 receives the beacon signal (the first beacon signal) from the power reception device 200 via the plurality of antennas 102, and AD-converts the received beacon signal by an ADC. The receiver 104 may perform amplification and band adjustment or the like of the received signal before or after AD conversion.

The controller 107 controls the entire power transmission device 100, and controls at least one or all of the transmission/reception switch 103, the receiver 104, the transmitter 105, the weight circuit 108, the high frequency device 109, and the communicator 110 for example.

The controller 107 detects a phase and an amplitude of the signal for each antenna 102 or detects a phase difference and an amplitude difference from predetermined values regarding the phase and the amplitude, and acquires a detection result as an estimation result of a channel with the power reception device 200 for each antenna 102.

The controller 107 determines a weight for each antenna 102 for performing transmission beam forming to the power reception device 200 based on the estimation result of the channel for each antenna 102. The controller 107 sends the weight determined for each antenna 102 to the weight circuit 108.

The weight circuit 108 sets the weight for each antenna 102 received from the controller 107 to the receiver 104 and the transmitter 105. For each antenna 102, the weight of a same value is set to the receiver 104 and the transmitter 105. Before the weight is set, a weight of an initial value may be set to the receiver 104 and the transmitter 105. The initial value may be a value that maintains (that does not change) the phase and the amplitude, or may be other values.

After the weight is set to the receiver 104 by the weight circuit 108, the receiver 104 receives the beacon signal (the second beacon signal) transmitted from the power reception device 200, adjusts the phase and the amplitude based on the weight set for each antenna 102, and outputs the adjusted signal to the controller 107. Reception of the signal from the power reception device 200 based on the weight for each antenna 102 is referred to as reception beam forming. While the phase and the amplitude are adjusted for each antenna 102 by the weight for each antenna 102 in the present embodiment, a configuration of adjusting only the phase is also possible. In this case, only adjustment of the amplitude needs to be omitted in the description regarding adjustment of the phase and the amplitude in the description below. The adjustment of the phase and the amplitude based on the weight in the reception beam forming may be performed in either a digital domain or an analog domain. In the case of the digital domain, the received signal is AD-converted by the ADC, and the phase and the amplitude of the AD-converted signal are adjusted based on the weight for each antenna 102. In the case of the analog domain, the phase and the amplitude may be adjusted in the signal before AD conversion, that is, the signal in the analog (a high frequency/a low frequency (baseband) after frequency conversion) domain. In this case, a phase shifter may be used for the adjustment of the phase. In addition, a variable gain amplifier or a variable attenuator may be used for the adjustment of the amplitude.

The controller 107 synthesizes the adjusted signal for each antenna 102 to acquire a beacon reception signal. The signal can be synthesized in either the digital domain or the analog domain. The controller 107 detects the amplitude of the acquired beacon reception signal. The controller 107 calculates propagation loss of the beacon signal based on a difference between the detected amplitude and the transmission power of the beacon signal indicated by the beacon power information acquired from the power reception device 200 in advance. The difference may be a ratio or subtraction. Due to symmetry of the channel, it is conceivable that, even in the case of performing the transmission beam forming by the same weight from the power transmission device 100 to the power reception device 200, the same or similar (unified as similar, hereinafter) propagation loss occurs in the power supply signal (the power signal) to be transmitted. That is, it is conceivable that the propagation loss at the time of actual power transmission (the power transmission with which the beam forming to the power reception device 200 is executed) is same as or similar to the propagation loss calculated at the time of reception beam forming. The controller 107 assumes that the similar propagation loss is to occur, and determines the transmission power of the transmission beam forming of the power supply signal. As an example, a value obtained by adding a value according to the propagation loss to the optimum reception power desired by the power reception device 200 is determined as the transmission power. Thus, a possibility that the power supply signal is received with the desired reception power of the power reception device 200 can be increased. The power for which the value according to the propagation loss is subtracted from the transmission power determined in this way is an estimated value of the reception power of the power reception device 200 at the time of the transmission beam forming.

The controller 107 controls the high frequency device 109 so as to generate a high frequency signal (the power supply signal) by the determined transmission power. For example, by changing setting of the amplifier provided in the high frequency device 109, the high frequency signal of the determined transmission power can be generated.

The transmitter 105 generates a transmission signal for each antenna 102 by adjusting the phase and the amplitude based on the weight for each antenna 102 for the high frequency signal supplied from the high frequency device 109, DA-converts the generated transmission signal by a DAC respectively, and transmits it from the antenna 102. The transmitter 105 may perform the band adjustment and the amplification or the like to the DA-converted signal. Transmission of the signal from the transmitter 105 based on the weight for each antenna 102 in this way is referred to as the transmission beam forming. A transmission beam with directivity to the power reception device 200 is formed by the transmission beam forming, and the power supply signal 150 is transmitted to the power reception device 200. While the adjustment of the phase or the like (the transmission beam forming) is performed in the digital domain before DA conversion here, the adjustment of the phase or the like (the transmission beam forming) using a phase shifter or the like may be performed in the analog domain, after the DA conversion specifically. The power supply signal 150 transmitted from the transmitter 105 is attenuated in the middle of propagation as described above, and is received as the optimum reception power (optimum input power of the RF-DC converter 202) by the power reception device 200. The reception power is converted to DC power via the RF-DC converter 202, and then charged to the storage battery 205 or supplied to the load device 208 or the like.

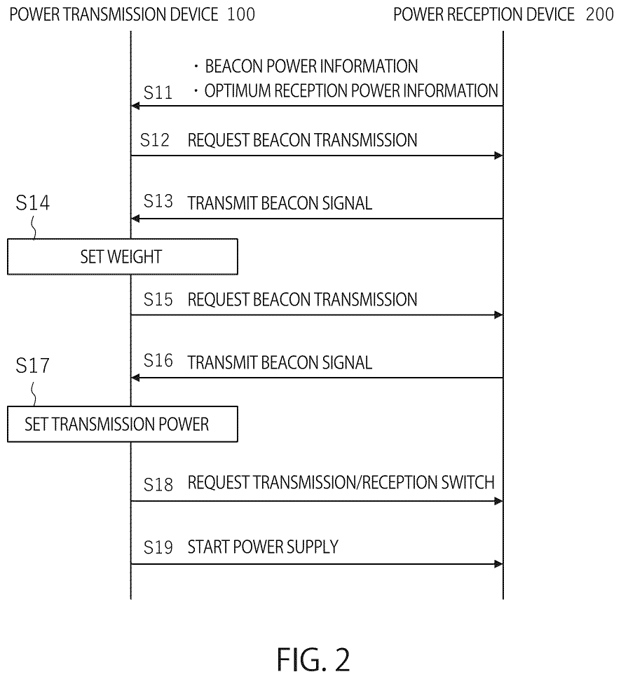

FIG. 2 illustrates an example of an operation flow of the wireless power supply system in FIG. 1. A timing of executing the present operation flow may be the time of activation, may be a timing at a fixed time interval or at an arbitrary time interval, or may be a timing for which an instruction is input from a user such as an administrator.

The communicator 207 of the power reception device 200 transmits the beacon power information and the optimum reception power information (S11). The beacon power information and the optimum reception power information may be simultaneously transmitted or may be separately transmitted. Note that the beacon power information and the optimum power value information may be transmitted every time the flow is executed, or may be transmitted only at the first time.

Next, a beacon transmission request requesting transmission of the beacon signal (the first beacon signal) is transmitted by wireless communication from the communicator 110 of the power transmission device 100 to the power reception device 200 (S12). The controller 206 of the power reception device 200 generates the first beacon signal using the signal generator 203, and transmits the first beacon signal from the antenna 201 (S13). The first beacon signal is received by the plurality of antennas 102 of the power transmission device 100, and the phase and the amplitude for each antenna 102 are detected in the controller 107. Note that the reception beam forming is not performed when the first beacon signal is received. The information on the phase and the amplitude for each antenna corresponds to channel information between the power transmission device 100 and the power reception device 200. Based on the channel information, the controller 107 determines the weight for each antenna 102 and notifies it to the weight circuit 108, and the weight circuit 108 sets the weight for each antenna 102 to the receiver 104 and the transmitter 105 (S14).

Next, the beacon transmission request requesting the transmission of the beacon signal (the second beacon signal) is transmitted from the communicator 110 of the power transmission device 100 to the power reception device 200 (S15). The controller 206 of the power reception device 200 generates the second beacon signal using the signal generator 203, and transmits the second beacon signal from the antenna 201 (S16). The second beacon signal is received by the reception beam forming corresponding to the power reception device 200 (that is, in a direction of the power reception device 200) by the weight set to the receiver 104. By detecting the amplitude of the second beacon signal in the controller 107 and comparing it with the transmission power indicated by the beacon power information, the propagation loss of the second beacon signal is detected.

The controller 107 estimates (calculates) a reception power value when the power supply signal reaches the power reception device 200 from the propagation loss and a transmission power value of the power supply signal. When the estimated reception power value exceeds the optimum power value described above, the transmission power of the power supply signal is determined to be such a value that the reception power value becomes equal to the optimum power value or does not exceed the power (S17). The determined value of the transmission power is set to the high frequency device 109 (same S17). Thus, the high frequency device 109 is set to generate the high frequency signal (power supply signal) of the set transmission power. When the estimated reception power value is lower than the optimum power value described above, the transmission power of the power supply value may be also set to such a value that the reception power value becomes equal to the optimum power value or does not exceed the power. However, it is on condition that the transmission power of the power supply signal does not exceed a value determined by law or the like. While comparison is made with the optimum power value here, comparison may be made with a maximum allowable power value or an allowable power range. When the comparison is to be made with the allowable power range, when the calculated reception power value is included in the range, the transmission power value (default value) for the power supply may be used without being changed.

A transmission/reception switch request is transmitted from the communicator 110 of the power transmission device 100 to the power reception device 200 (S18). The controller 206 of the power reception device 200 controls the transmission/reception switch 204 and switches the connection target of the antenna 201 to the RF-DC converter 202 based on the transmission/reception switch request. Thus, the power reception device 200 is turned to a power reception standby state. The controller 107 of the power transmission device 100 causes the high frequency device 109 to generate the high frequency signal (the power supply signal) with the transmission power value. The transmitter 105 transmits the generated high frequency signal from the plurality of antennas 102 by the set weight. That is, the power supply signal 150 is transmitted to the power reception device 200 by the transmission beam forming (S19).

While the beacon transmission request is transmitted in order to make the power reception device 200 transmit the second beacon signal in the flow in FIG. 2 described above, the configuration where the transmission of the beacon transmission request is omitted is also possible. For example, According to the beacon transmission request transmitted in order to make the first beacon signal be transmitted, the power reception device 200 may transmit the first beacon signal and then voluntarily transmit the second beacon signal after fixed time. Alternatively, the power reception device 200 may transmit the first beacon signal and then continuously transmit the second beacon signal.

As above, according to the present embodiment, efficient power transmission is made possible without providing reception power measurer in the power reception device 200 and without causing saturation and permanent damage of the reception power in the rectifier in the power reception device 200. Further, since the channel is estimated by receiving the beacon signal by the weight setting same as the weight used at the time of the actual power supply (power transmission), the propagation loss at the time of the actual power transmission can be estimated with high accuracy. Thus, the power can be transmitted with the power with which the power reception device 200 can perform a rectification operation with high efficiency, and risks of the saturation and permanent damage of the rectifier can be greatly reduced.

### Second Embodiment

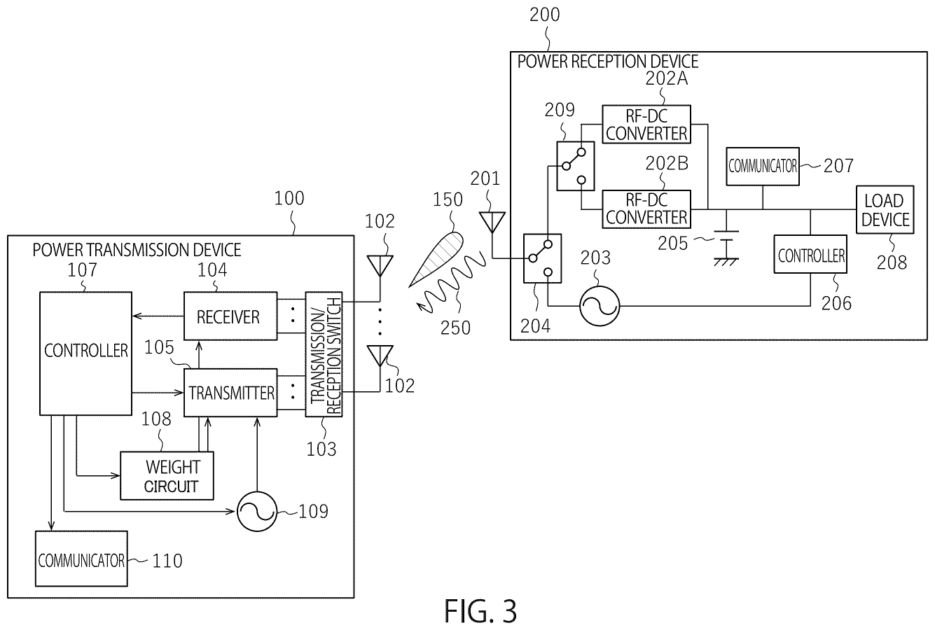

FIG. 3 is a block diagram illustrating an entire configuration of a wireless power supply system according to the present embodiment. Elements having same names as those in FIG. 1 are denoted by same signs, and the description is appropriately omitted except for extended or changed processing. Hereinafter, differences from the first embodiment will be mainly described.

The power reception device 200 includes a plurality of RF-DC converters. In the present example, an RF-DC converter 202A and an RF-DC converter 202B are provided. The number of RF-DC converters may be three or larger. Further, the RF-DC converters 202A and 202B have different power conversion characteristics and different optimum input power, respectively.

In addition, the power reception device 200 includes a switch 209 that switches the RF-DC converter to be used from the RF-DC converter 202A and the RF-DC converter 202B. The switch 209 switches the connection target of the antenna 201 between the RF-DC converters 202A and 202B. Each RF-DC converter can be switched by other devices. Switching of the switch 209 is controlled by the controller 206. In order to prevent an output current of one RF-DC converter of the RF-DC converters 202A and 202B from being input (flowing back) to an output side of the other RF-DC converter which is not to be used, a backflow prevention element such as a diode may be provided on each output side of the RF-DC converters 202A and 202B.

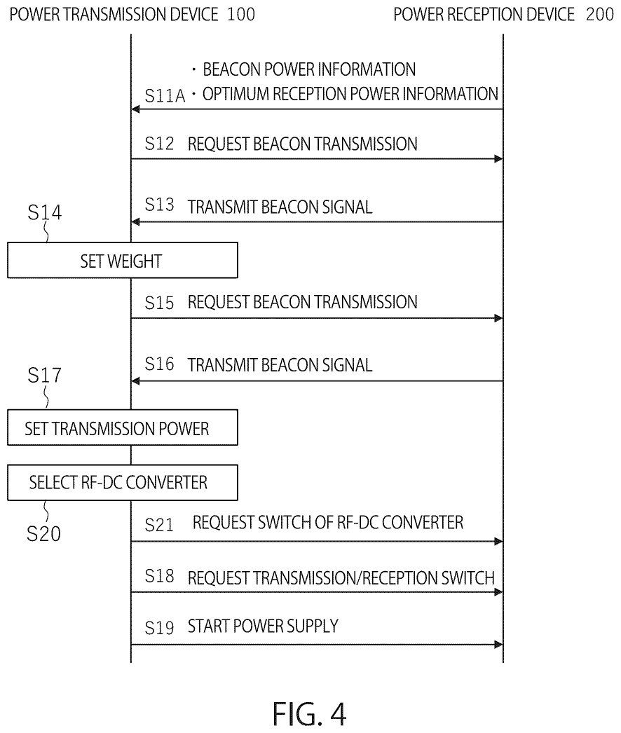

FIG. 4 illustrates an example of an operation flow of the wireless power supply system in FIG. 3. The same operations as those in FIG. 2 described above are denoted by same signs and the description in common with the first embodiment is appropriately omitted. Hereinafter, differences from the operation flow of the first embodiment will be mainly described.

The communicator 207 of the power reception device 200 transmits the beacon power information and the optimum reception power information of each RF-DC converter to the power transmission device 100 (S11A). The optimum power value information may be maximum allowable power information for example.

Since steps S12 to S16 are the same operations as steps S12 to S16 in FIG. 2, the description is omitted.

In step S17, similarly to step S17 in FIG. 2, the transmission power of the power supply signal is determined such that the reception power value of the power reception device 200 becomes equal to the optimum power value (or an allowable maximum power value or the like) or does not exceed the power, and the determined value of the transmission power is set to the high frequency device 109 (same S17).

In following step S20, the controller 107 of the power transmission device 100 compares the estimated reception power with optimum input values of the RF-DC converters 202A and 202B of the power reception device 200, and selects the RF-DC converter having the optimum input value closest to the estimated reception power.

In following step S21, the communicator 110 transmits a switch request to the selected RF-DC converter to the power reception device 200 as information indicating the selected RF-DC converter. The controller 206 of the power reception device 200 which receives the switch request controls the switch 209 so as to switch the connection target of the antenna 201 to the RF-DC converter indicated by the switch request.

Since following steps S18 and S19 are the same operations as steps S18 and S19 in FIG. 2, the description is omitted.

As above, according to the present embodiment, in addition to effects of the first embodiment, by selecting the RF-DC converter according to the estimated reception power of the power supply signal received by the power reception device, optimum RF-DC conversion according to the reception power is made possible. Thus, the power can be efficiently supplied to the power reception device.

### Third Embodiment

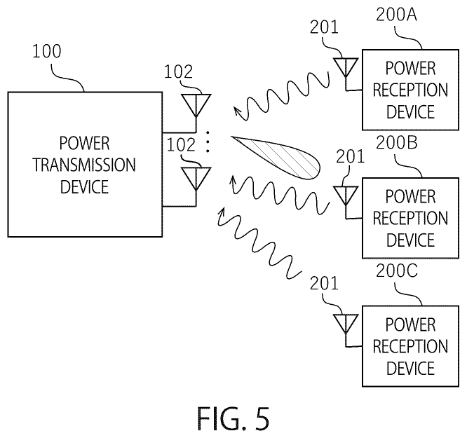

FIG. 5 is a block diagram illustrating an entire configuration of a wireless power supply system according to the present embodiment. Elements having same names as those in FIG. 1 are denoted by same signs, and the description is appropriately omitted except for extended or changed processing. Hereinafter, differences from the first embodiment will be mainly described.

The wireless power supply system in FIG. 5 includes the power transmission device 100 and a plurality of power reception devices 200A, 200B, and 200C. A block diagram of the power transmission device 100 and a block diagram of the power reception devices 200A to 200C are the same as those in FIG. 1, but some operations are extended.

The communicator 207 in each of the power reception devices 200A to 200C transmits battery residual amount information which is measurement information related to a residual amount or a voltage of the storage battery 205 to the power transmission device 100, in addition to the beacon power information and the optimum reception power information in the first embodiment. The battery residual amount information may be a value of a battery residual amount (remaining power amount) of the storage battery 205, may be a ratio (SOC) of the battery residual amount to the entire capacity of the storage battery 205, or may be the voltage (for example, a charge voltage or a discharge voltage) of the storage battery 205. Since the charge voltage or the discharge voltage depends on the battery residual amount of the storage battery 205, the battery residual amount can be estimated from the voltage of the storage battery 205. The battery residual amount or the voltage can be acquired from a measurer provided in the storage battery 205 so that it is not necessary to add a new measuring device. Note that the battery residual amount information may be transmitted in the first embodiment.

The controller 107 in the power transmission device 100 generates a power supply schedule for each power reception device based on the estimated reception power of each power reception device estimated similarly to the first embodiment and the battery residual amount of each power reception device. For example, an order of the power reception devices to supply the power and time (a period) to supply the power are determined. The controller 107 performs control so as to supply the power to each power reception device according to the generated power supply schedule.

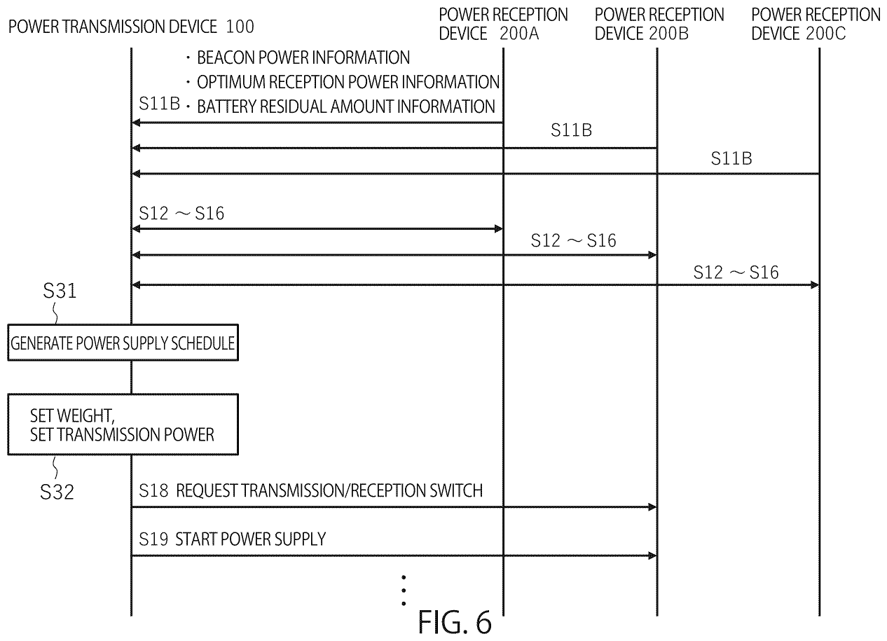

FIG. 6 illustrates an example of an operation flow of the wireless power supply system in FIG. 5. The same operations as those in FIG. 2 of the first embodiment are denoted by same signs and the description in common with the first embodiment is appropriately omitted. Hereinafter, differences from the operation flow of the first embodiment will be mainly described.

The communicator 207 of the power reception devices 200A to 200C transmits the beacon power information, the optimum reception power information, and the battery residual amount information to the power transmission device 100 (S11B).

The power transmission device 100 performs the processing of steps S12 to S16 same as those in FIG. 2 in the first embodiment in order with each of the power reception devices 200A to 200C. Thus, the propagation loss by the reception beam forming and the reception power are estimated. Note that the weight of the antenna 102 is set to the initial value before the processing of steps S12 to S16 for each reception device.

The controller 107 of the power transmission device 100 generates the power supply schedule for each power reception device based on the estimated value of the reception power and a battery residual amount value for each power reception device (S31). Specifically, the order of the power reception devices to supply the power and the power supply time (period) are determined. As an example, the order of the power supply is determined so as to supply the power in order from the one with the smallest battery residual amount. The power supply time is the time needed for the battery residual amount to reach a predetermined standard value. When the estimated value of the reception power is a threshold or smaller (when there is an obstacle between the power transmission device and the power reception device and a radio wave state is bad, for example), since the power cannot be efficiently supplied, the order of the power supply may be delayed or turned to the last. Alternatively, the power reception device may be excluded from a power supply target until the estimated value of the reception power becomes the threshold or larger.

In the example of FIG. 6, the power reception device 200B is selected first according to the power supply schedule. The controller 107 of the power transmission device 100 sets the weight and the transmission power value determined in steps S12 to S16 for the power reception device 200B to the transmitter 105 and the high frequency device 109 (S32). Thereafter, it is similar to the first embodiment. That is, the power transmission device 100 transmits the transmission/reception switch request to the power reception device 200B (S18). Then, the power transmission device 100 transmits the high frequency signal (the power supply signal) generated by the high frequency device 109 to the power reception device 200B by the transmission beam forming by the weight set to the transmitter 105 (S19). When the power supply to the power reception device 200B is completed, the power transmission device 100 repeats selection of the next power reception device and the processing of steps S32, S18, and S19 thereafter according to the power supply schedule.

As above, according to the present embodiment, by utilizing the battery residual amount information of each power reception device, the power supply order and the power supply time of the entire power supply system can be optimized and thus the power can be efficiently supplied. Further, since the battery residual amount information can be acquired from the measurer (a battery charge circuit, specifically) originally provided in the battery, it is not necessary to add a new configuration for additional measurement to the power reception device so that a cost increase of the power reception device can be suppressed.

### Fourth Embodiment

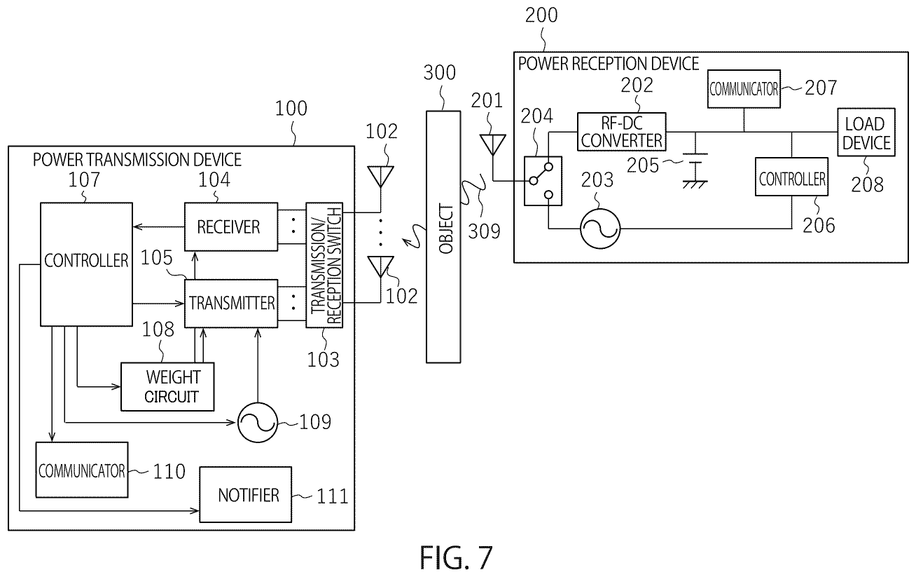

FIG. 7 is a block diagram illustrating an entire configuration of a wireless power supply system according to the present embodiment. Elements having same names as those in FIG. 1 are denoted by same signs, and the description is appropriately omitted except for extended or changed processing. Hereinafter, differences from the first embodiment will be mainly described.

The block diagram of the power reception device 200 is the same as that in FIG. 1. The power transmission device 100 additionally includes a notifier 111. The notifier 111 is controlled by the controller 107.

After the power supply by the transmission beam forming is started from the power transmission device 100 to the power reception device 200 similarly to the first embodiment, it is assumed that a situation where an object 300 is positioned between the power transmission device 100 and the power reception device 200 has occurred as illustrated in FIG. 7. Such a situation may occur due to movement of the power reception device 200 or due to movement of the object 300. As an example of the movement of the power reception device 200, the power reception device 200 may be attached to an arm of a robot for example and the object 300 may be positioned between the power reception device 200 and the power transmission device 100 according to the movement of the arm. In this case, the object 300 may be a part of the robot or may be an object different from the robot.

When the object 300 is positioned between the power transmission device 100 and the power reception device 200, since a beacon signal 309 is reflected or absorbed at the object 300, the power rapidly decreases and reaches the power transmission device 100. When the situation like this occurs, the reception power value estimated in the power transmission device 100 greatly decreases. When rapid decline of the reception power of the beacon signal is detected, the controller 107 detects occurrence of an abnormal situation such as presence of the object between the power transmission device 100 and the power reception device 200. For example, when the reception power value of the beacon signal declines by a predetermined value or more, the occurrence of the abnormal situation is detected.

The notifier 111 in the power transmission device 100 transmits information notifying the occurrence of the abnormal situation according to a detection result of the controller 107. For example, the notifier 111 displays the information indicating the occurrence of the abnormal situation on a screen. When the notifier 111 includes a screen, it may be displayed on the screen of the notifier 111, or it may be displayed on a screen of another device that can communicate with the power transmission device 100. Alternatively, the notifier 111 may output the information indicating the occurrence of the abnormal situation by sound. A speaker that outputs the sound may be provided in the notifier 111 or may be provided in another device that can communicate with the power transmission device 100. A transmission target of the information may be a terminal that an administrator has.

When the occurrence of the abnormal situation is detected, the controller 107 may stop the power supply to the power reception device 200. When a power reception device to be a power supply target is present other than the power reception device 200, a power supply target may be switched to the other power reception device.

As above, according to the present embodiment, the administrator or the like can be notified when the abnormality such as the presence of the object occurs, and the abnormality can be dissolved in an early stage.

### Fifth Embodiment

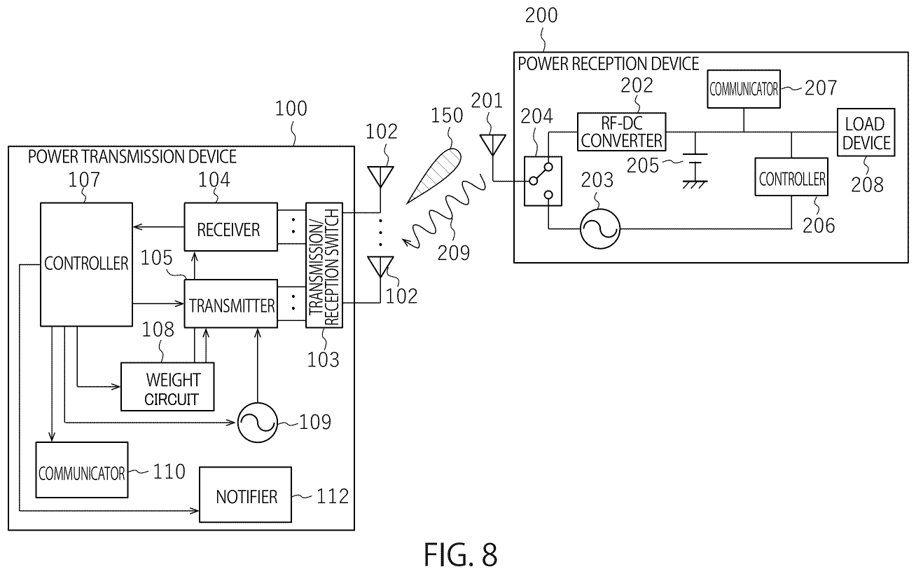

FIG. 8 is a block diagram illustrating an entire configuration of a wireless power supply system according to the present embodiment. The block diagram of the power transmission device 100 is the same as that in FIG. 7. The block diagram of the power reception device 200 is the same as that in FIG. 1. Elements having same names as those in FIG. 1 or FIG. 7 are denoted by same signs, and the description is appropriately omitted except for extended or changed processing. Hereinafter, differences from the first embodiment will be mainly described.

The power transmission device 100 includes a notifier 112. The notifier 112 is controlled by the controller 107.

The communicator 207 of the power reception device 200 acquires the battery residual amount information (the battery residual amount or a battery voltage or the like) and transmits it to the power transmission device 100 similarly to the third embodiment described above.

The power transmission device 100 performs the transmission beam forming based on the transmission power and the weight determined similarly to the first embodiment, and transmits the power supply signal to the power reception device 200. When a situation where the battery residual amount is small or the battery voltage is small in the power reception device 200 continues even though the reception power estimated value of the power reception device 200 is the predetermined value or larger, the controller 107 of the power transmission device 100 detects occurrence of abnormality in the power reception device 200. For example, when the battery residual amount estimated from the reception power estimated value and the power supply time by then is smaller by the predetermined value or more compared to the battery residual amount indicated by the battery residual amount information received from the power reception device 200, the occurrence of the abnormality is detected. In addition, when the battery voltage assumed from the estimated battery residual amount is smaller than the battery voltage indicated by the battery residual amount information by the predetermined value or more, the occurrence of the abnormality is detected. Examples of the occurrence of the abnormality include decline of battery charge efficiency due to permanent damage of the RF-DC converter, and increase in current consumption due to permanent damage of a load device (a sensor, for example).

The notifier 112 in the power transmission device 100 transmits information notifying the occurrence of the abnormal situation according to a detection result of the controller 107. For example, the notifier 112 displays the information indicating the occurrence of the abnormal situation on a screen. When the notifier 112 includes a screen, it may be displayed on the screen of the notifier 112, or it may be displayed on a screen of another device that can communicate with the power transmission device 100. Alternatively, the notifier 112 may output the information indicating the occurrence of the abnormal situation by sound. A speaker that outputs the sound may be provided in the notifier 112 or may be provided in another device that can communicate with the power transmission device 100.

As above, according to the present embodiment, abnormality such as a permanent damage in the RF-DC converter or the load device or the like in the power reception device 200 can be detected. Further, the abnormality can be dissolved in an early stage by notifying the occurrence of the abnormality to the administrator.

### Application Example

While an example of applying the present invention to the power supply system by microwaves is illustrated in the first to fifth embodiments, the present invention is also applicable to optimization of wireless communication or the like. For example, when a base station performs the transmission beam forming to a terminal, it is possible to allow the terminal to receive the signal of the beam forming from the base station with the reception power suitable for the terminal while simplifying the configuration of the terminal.

Note that the present invention is not limited to the embodiments as described above, and can be embodied by modifying components without departing from its spirit at the implementation stage. In addition, various inventions can be formed by appropriate combinations of a plurality of components disclosed in the above-described embodiments. For example, some components may be deleted from all the components shown in the embodiments. Furthermore, components from different embodiments may be appropriately combined.

The embodiments as described before may be configured as below.

### CLAUSES

Clause 1. A wireless power supply device comprising:
a receiver configured to receive a first signal from a power reception device via a plurality of antennas; and
a controller configured to determine a plurality of weights used for the plurality of antennas based on a reception signal of the first signal,
wherein the receiver receives a second signal from the power reception device by reception beam forming based on the plurality of weights,
the controller determines transmission power of a power signal to be transmitted to the power reception device based on reception power of the second signal, and
the wireless power supply device further comprises a transmitter configured to transmit the power signal based on the transmission power by transmission beam forming based on the plurality of weights.

Clause 2. The wireless power supply device according to Clause 1,
wherein the controller calculates propagation loss between the wireless power supply device and the power reception device based on transmission power of the first signal and the reception power of the second signal, and determines the transmission power of the power signal based on the calculated propagation loss.

Clause 3. The wireless power supply device according to Clause 2,
wherein the controller estimates reception power of the power signal in the power reception device based on the calculated propagation loss, and selects a rectifier to be used for rectifying the power signal from a plurality of rectifiers in the power reception device based on an estimated value of the reception power, and
the wireless power supply device comprises a communicator configured to transmit instruction information instructing use of the selected rectifier.

Clause 4. The wireless power supply device according to Clause 3,
wherein the plurality of rectifiers have different power conversion efficiency characteristics respectively as power conversion efficiency characteristics between input power and output power, and
the controller selects the rectifier based on the power conversion efficiency characteristics of the plurality of rectifiers.

Clause 5. The wireless power supply device according to Clause 3,
wherein the controller selects the rectifier to be used by the power reception device based on correspondence information in which the estimated value of the reception power of the power signal in the power reception device and the rectifier to be used are made to correspond.

Clause 6. The wireless power supply device according to any one of Clauses 1 to 5, comprising a communicator configured to receive measurement information related to a residual amount or a voltage of a storage battery configured to perform charging based on the power signal in the power reception device for each of the plurality of power reception devices,
wherein the controller calculates propagation loss between the wireless power supply device and the power reception device based on transmission power of the first signal and the reception power of the second signal, and estimates reception power of the power signal in the power reception device based on the calculated propagation loss, and
the controller determines an order of the power reception devices to transmit the power signal based on the received measurement information and an estimated value of the reception power of the power signal in each power reception device.

Clause 7. The wireless power supply device according to any one of Clauses 1 to 6,
wherein the controller determines the plurality of weights by estimating a channel with the power reception device for each antenna based on an amplitude and a phase of each antenna of the reception signal of the first signal.

Clause 8. The wireless power supply device according to Clause 7,
wherein the controller detects deterioration of a propagation environment of radio waves between the wireless power supply device and the power reception device based on results of estimating the channel for multiple times, and
the wireless power supply device comprises a notifier configured to output notification information indicating the deterioration of the propagation environment.

Clause 9. The wireless power supply device according to Clause 8,
wherein the deterioration of the propagation environment includes presence of an obstacle for radio wave propagation between the wireless power supply device and the power reception device.

Clause 10. The wireless power supply device according to any one of Clauses 1 to 9, comprising a communicator configured to receive measurement information related to a residual amount or a voltage of a storage battery that performs charging based on the power signal in the power reception device,
wherein the controller calculates propagation loss between the wireless power supply device and the power reception device based on transmission power of the first signal and the reception power of the second signal, and estimates reception power of the power signal in the power reception device based on the calculated propagation loss,
the controller detects occurrence of abnormality in the power reception device based on the measurement information and an estimated value of the reception power of the power signal in the power reception device, and
the wireless power supply device further comprises a notifier configured to output information indicating the detected occurrence of the abnormality.

Clause 11. The wireless power supply device according to claim 10,
wherein the abnormality includes abnormality of a rectifier that rectifies the power signal in the power reception device, or increase in current consumption of a load device that consumes power of the storage battery in the power reception device.

Clause 12. The wireless power supply device according to any one of Clauses 1 to 11,
wherein the first signal and the second signal are beacon signals.

Clause 13. A wireless power supply system comprising:
a power reception device; and
a wireless power supply device,
wherein the power reception device includes a controller configured to perform control of transmitting a first signal and a second signal via an antenna,
the wireless power supply device includes
a receiver configured to receive the first signal from the power reception device via a plurality of antennas, and
a controller configured to determine a plurality of weights to be used in the plurality of antennas based on the reception signal of the first signal,
the receiver receives the second signal from the power reception device by reception beam forming based on the plurality of weights,
the controller determines transmission power of a power signal to be transmitted to the power reception device based on reception power of the second signal,
the wireless power supply device includes a transmitter configured to transmit the power signal based on the transmission power by transmission beam forming based on the plurality of weights, and
the power reception device receives the power signal via the antenna and includes a rectifier configured to rectify the power signal.

1. A wireless power supply device comprising:
a receiver configured to receive a first signal from a power reception device via a plurality of antennas; and
a controller configured to determine a plurality of weights used for the plurality of antennas based on a reception signal of the first signal,
wherein the receiver receives a second signal from the power reception device by reception beam forming based on the plurality of weights,
the controller determines transmission power of a power signal to be transmitted to the power reception device based on reception power of the second signal, and
the wireless power supply device further comprises a transmitter configured to transmit the power signal based on the transmission power by transmission beam forming based on the plurality of weights.

2. The wireless power supply device according to claim 1,
wherein the controller calculates propagation loss between the wireless power supply device and the power reception device based on transmission power of the first signal and the reception power of the second signal, and determines the transmission power of the power signal based on the calculated propagation loss.

3. The wireless power supply device according to claim 2,
wherein the controller estimates reception power of the power signal in the power reception device based on the calculated propagation loss, and selects a rectifier to be used for rectifying the power signal from a plurality of rectifiers in the power reception device based on an estimated value of the reception power, and
the wireless power supply device comprises a communicator configured to transmit instruction information instructing use of the selected rectifier.

4. The wireless power supply device according to claim 3,
wherein the plurality of rectifiers have different power conversion efficiency characteristics respectively as power conversion efficiency characteristics between input power and output power, and
the controller selects the rectifier based on the power conversion efficiency characteristics of the plurality of rectifiers.

5. The wireless power supply device according to claim 3,
wherein the controller selects the rectifier to be used by the power reception device based on correspondence information in which the estimated value of the reception power of the power signal in the power reception device and the rectifier to be used are made to correspond.

6. The wireless power supply device according to claim 1, comprising a communicator configured to receive measurement information related to a residual amount or a voltage of a storage battery configured to perform charging based on the power signal in the power reception device for each of the plurality of power reception devices,
wherein the controller calculates propagation loss between the wireless power supply device and the power reception device based on transmission power of the first signal and the reception power of the second signal, and estimates reception power of the power signal in the power reception device based on the calculated propagation loss, and
the controller determines an order of the power reception devices to transmit the power signal based on the received measurement information and an estimated value of the reception power of the power signal in each power reception device.

7. The wireless power supply device according to claim 1,
wherein the controller determines the plurality of weights by estimating a channel with the power reception device for each antenna based on an amplitude and a phase of each antenna of the reception signal of the first signal.

8. The wireless power supply device according to claim 7,
wherein the controller detects deterioration of a propagation environment of radio waves between the wireless power supply device and the power reception device based on results of estimating the channel for multiple times, and
the wireless power supply device comprises a notifier configured to output notification information indicating the deterioration of the propagation environment.

9. The wireless power supply device according to claim 8,
wherein the deterioration of the propagation environment includes presence of an obstacle for radio wave propagation between the wireless power supply device and the power reception device.

10. The wireless power supply device according to claim 1, comprising a communicator configured to receive measurement information related to a residual amount or a voltage of a storage battery that performs charging based on the power signal in the power reception device,
wherein the controller calculates propagation loss between the wireless power supply device and the power reception device based on transmission power of the first signal and the reception power of the second signal, and estimates reception power of the power signal in the power reception device based on the calculated propagation loss,
the controller detects occurrence of abnormality in the power reception device based on the measurement information and an estimated value of the reception power of the power signal in the power reception device, and
the wireless power supply device further comprises a notifier configured to output information indicating the detected occurrence of the abnormality.

11. The wireless power supply device according to claim 10,
wherein the abnormality includes abnormality of a rectifier that rectifies the power signal in the power reception device, or increase in current consumption of a load device that consumes power of the storage battery in the power reception device.

12. The wireless power supply device according to claim 1,
wherein the first signal and the second signal are beacon signals.

13. A wireless power supply system comprising:
a power reception device; and
a wireless power supply device,
wherein the power reception device includes a controller configured to perform control of transmitting a first signal and a second signal via an antenna,
the wireless power supply device includes
a receiver configured to receive the first signal from the power reception device via a plurality of antennas, and
a controller configured to determine a plurality of weights to be used in the plurality of antennas based on the reception signal of the first signal,
the receiver receives the second signal from the power reception device by reception beam forming based on the plurality of weights,
the controller determines transmission power of a power signal to be transmitted to the power reception device based on reception power of the second signal,
the wireless power supply device includes a transmitter configured to transmit the power signal based on the transmission power by transmission beam forming based on the plurality of weights, and
the power reception device receives the power signal via the antenna and includes a rectifier configured to rectify the power signal.
